(19) United States
(12) Patent Application Publication
(10) Pub. No.: US 2020/0256713 A1
(43) Pub. Date: Aug. 13, 2020

(54) SYSTEM FOR SHUTTING-OFF FLUID FLOW AND MEASURING FLUID FLOW RATE

(71) Applicant: Caterpillar Inc., Deerfield, IL (US)

(72) Inventor: Todd Ryan Kabrich, Lafayette, IN (US)

(73) Assignee: Caterpillar Inc., Deerfield, IL (US)

(21) Appl. No.: 16/274,754

(22) Filed: Feb. 13, 2019

(51) Int. Cl. G01F 1/40; G01F 15/00; G01F 1/50; F02D 19/02; F02C 7/232

(52) U.S. Cl. CPC G01F 1/40; G01F 15/005; F02C 7/232; F02D 19/027; F02D 19/022; G01F 1/50

(57) ABSTRACT

A system for shutting-off fluid flow and measuring fluid flow rate may include a housing defining an inlet, a valve body chamber, and an outlet opposite the inlet. The system may also include a valve body at least partially received in the valve body chamber, and an actuator coupled to the valve body and configured to reposition and/or re-orient the valve body. The system may also include at least one pressure sensor configured to generate a pressure differential signal indicative of a pressure difference between pressure at the inlet and the outlet, and a controller configured to receive a valve body signal indicative of a valve body position and/or orientation and the pressure differential signal, and determine a flow rate of fluid flowing through the housing based at least in part on the valve body signal and/or the pressure differential signal.

### TECHNICAL FIELD

The present disclosure relates to a system for shutting-off fluid flow and measuring fluid flow rate, and more particularly, to a system for shutting-off fluid flow and measuring fluid flow rate having improved turndown ratio characteristics.

### BACKGROUND

The control of fluid flow in systems and machines may be important for the proper and efficient operation of the system or machine. Fluid systems may include various sensors, valves, and other devices to control the flow of fluid in the fluid system. For example, some fluid systems may include one or more sensors configured to generate signals indicative of characteristics of the fluid flow, and the fluid system may include flow regulators and valves to cause the fluid to flow through the fluid system in a manner that facilitates operation of the system or machine in which the fluid flows. For example, it may be desirable to measure the flow rate of fluid at one or more locations in the fluid system and/or, under some circumstances, to shut-off the fluid flow at one or more locations of the fluid system. In systems and machines, the flow rate of the fluid may vary greatly at particular locations in the fluid system depending on operation of the systems and machines. Accurately measuring flow rates throughout the range of flow rates may present difficulties. For example, a device may be capable of measuring flow rate only within a limited range of flow rates. As a result, it may be desirable to provide a device for measuring flow rate across a broad range of flow rates that may occur in the fluid system. In some applications, it may also be desirable to stop fluid flow under particular circumstances. Thus, it may also be desirable to provide a device that effectively stops fluid flow.

An attempt to measure and control fluid flow rate is described in U.S. Patent Application Publication No. US 2017/0090485 A1 to Ohashi et al. (“the '485 publication”), published Mar. 30, 2017. Specifically, the '485 publication describes a method and system for measuring and controlling a flow rate of a valve by correcting a valve opening measurement value with the use of a correction value. According to the '485 publication, the correction value corresponds to an amount of twist of a valve stem determined using the valve opening measurement value and a differential pressure detection value. The '485 publication also describes calculating a flow rate of a fluid flowing in a pipeline on the basis of a corrected valve opening and the differential pressure detection value. According to the '485 publication, the calculated flow rate of the fluid is set as a measured flow rate, and the amount of rotation of the valve stem is controlled, so that the measured flow rate matches a set flow rate.

Although the '485 publication purports to provide a flow rate calculating device and a flow rate calculation method capable of enhancing measurement precision for flow rate and a device capable of realizing a flow rate control with high precision, the device and method of the '485 publication may be unsuitable for measuring flow rates across a wide range of flow rates. The device and method disclosed herein may be directed to mitigating or overcoming one or more of the possible drawbacks set forth above.

### SUMMARY

According to a first aspect, a system for shutting-off fluid flow and measuring fluid flow rate may include a housing defining an inlet configured to receive a fluid, a valve body chamber, and an outlet opposite the inlet relative to the valve body chamber. The system may also include a valve body at least partially received in the valve body chamber, and an actuator coupled to the valve body and configured to at least one of reposition the valve body relative to the valve body chamber or re-orient the valve body relative to the valve body chamber. The system may also include at least one pressure sensor in flow communication with the housing. The at least one pressure sensor may be configured to generate a pressure differential signal indicative of a pressure difference between an inlet fluid pressure associated with the inlet and an outlet fluid pressure associated with the outlet. The system may also include a controller configured to receive a valve body signal indicative of at least one of a valve body position of the valve body or a valve body orientation of the valve body. The controller may also be configured to receive the pressure differential signal indicative of the pressure difference, and determine a flow rate of a fluid flowing through the housing based at least in part on at least one of the valve body signal and the pressure differential signal.

According to a further aspect, a system for shutting-off fluid flow and measuring fluid flow rate may include a housing defining an inlet configured to receive a fluid, a valve body chamber, and an outlet opposite the inlet relative to the valve body chamber. The system may also include a valve body at least partially received in the valve body chamber, and an actuator coupled to the valve body and configured to change at least one of an area through which the fluid flows through the housing or a flow coefficient associated with fluid flow through the housing. The system may also include at least one pressure sensor in flow communication with the housing. The at least one pressure sensor may be configured to generate a pressure differential signal indicative of a pressure difference between an inlet fluid pressure associated with the inlet and an outlet fluid pressure associated with the outlet. The system may also include a controller configured to receive a valve body signal indicative of at least one of a valve body position or a valve body orientation, and receive the pressure differential signal indicative of the pressure difference. The controller may also be configured to determine a flow rate of a fluid flowing through the housing based at least in part on at least one of the valve body signal and the pressure differential signal.

According to another aspect, a system for shutting-off fluid flow and measuring fluid flow rate may include a housing defining an inlet configured to receive a fluid, a valve body chamber, and an outlet opposite the inlet relative to the valve body chamber. The system may also include a valve body at least partially received in the valve body chamber, and an actuator coupled to the valve body and configured to at least one of reposition the valve body or re-orient the valve body. The system may also include at least one pressure sensor in flow communication with the housing. The at least one pressure sensor may be configured to generate a pressure differential signal indicative of a pressure difference between an inlet fluid pressure associated with the inlet and an outlet fluid pressure associated with the outlet. The system may further include a controller configured to determine a first flow rate through the housing based at least in part on a first pressure differential signal, the first flow rate being within a first range of flow rates. The controller may also be configured to cause the actuator to at least one of (1) reposition the valve body from a first position to a second position or (2) re-orient the valve body from a first orientation to a second orientation. The controller may also be configured to determine a second flow rate through the housing based at least in part on a second pressure differential signal. The second flow rate may be within a second range of flow rates, and the second range of flow rates may be different than the first range of flow rates.

### BRIEF DESCRIPTION OF THE DRAWINGS

The detailed description is described with reference to the accompanying figures. In the figures, the left-most digit of a reference number identifies the figure in which the reference number first appears. The same reference numbers in different figures indicate similar or identical items.

FIG. 1 schematically depicts an example fluid system including an example system for shutting-off fluid flow and measuring fluid flow rate.

FIG. 2 schematically depicts an example fluid system including an example system for shutting-off fluid flow and measuring fluid flow rate.

FIG. 3 is a perspective section view of an example multi-position fluid shut-off valve.

FIG. 4 is a section view of an example multi-position fluid shut-off valve and two schematically-depicted example pressure sensors.

### DETAILED DESCRIPTION

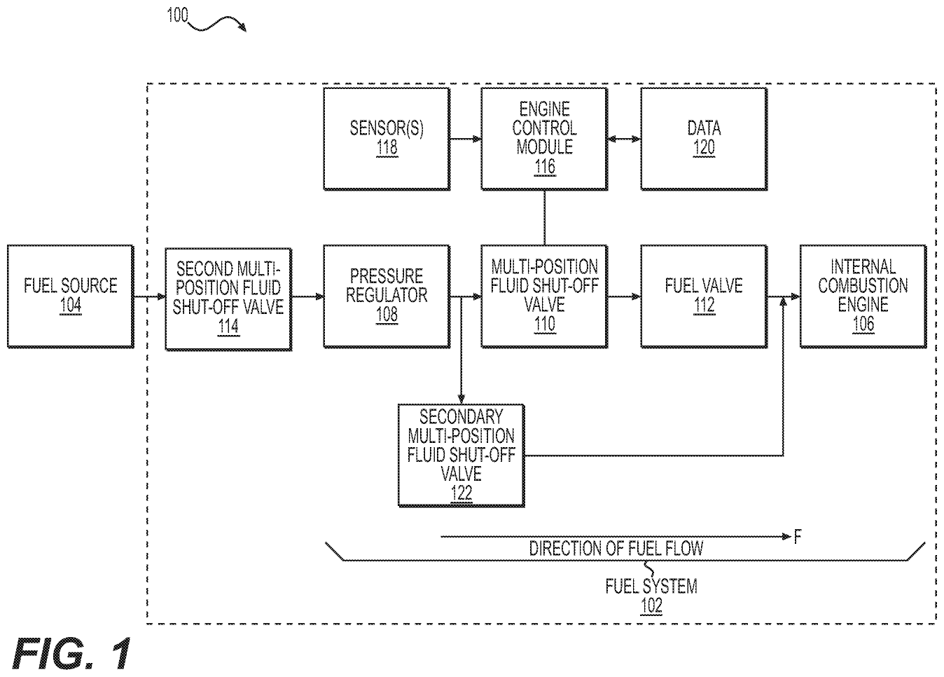

FIG. 1 schematically depicts an example fluid system 100. Example fluid system 100 shown in FIG. 1 includes a fuel system 102 including a fuel source 104, such as, for example, a reservoir or tank, from which a volume a fuel may be drawn via flow communication with other portions of example fuel system 102, for example, via one or more pumps. Although example fluid system 100 shown in FIG. 1 is a fuel system for delivering fuel in a controlled manner to an example internal combustion engine 106, other types of fluid systems are contemplated. For example, the fluid may include, for example, one or more of fuel, lubricants, coolants, and/or hydraulic fluid used by machines. Other types of fluids are contemplated. Although fluid system 100 shown in FIG. 1 supplies fuel to internal combustion engine 106, fluid system 100 may supply fluid to any type of machine, such as, for example, an excavator, a generator, an internal combustion engine, a transmission, an HVAC system, and/or any other machine or system known to a person skilled in the art.

Example fuel system 102 shown in FIG. 1 communicates fuel in the direction of fuel flow F between fuel source 104 and internal combustion engine 106. In some examples, fuel system 102 includes a pressure regulator 108, through which fuel passes from fluid source 104 to a multi-position fluid shut-off valve 110, and from multi-position shut-off valve 110 to a fuel valve 112, which may serve as, for example, a trimmer valve or other valve type for providing fuel in a controlled manner to internal combustion engine 106. As explained herein, some examples of multi-position shut-off valve 110 may be configured to serve as a fluid shut-off valve and a fluid flow rate measuring device, for example a flow rate measuring device having a changeable range of measurable flow rates.

In some examples, fuel system 102 may include a fuel filter, for example, between fuel source 104 and pressure regulator 108, and/or between pressure regular 108 and multi-position shut-off valve 110. In some examples, fuel system 102 may provide fuel to one or more combustion chambers (or cylinders) of internal combustion engine 106. In some examples, fuel system 102 may be one of a plurality of at least similar fuel systems providing fuel to internal combustion engine 106. Additionally, or alternatively, fuel system 102 may include a plurality of branches providing flow communication to one or more other components of fuel system 102, for example, such that there may be multiple multi-position fluid shut-off valves, multiple pressure regulators, and/or multiple fuel valves. In some examples, a plurality of multi-position fluid shut-off valves may be placed in series, for example, such that one or more of the plurality of multi-position fluid shut-off valves serve as a backup or backups to others.

Some examples of fuel system 102 may include at least a second multi-position fluid shut-off valve 114 different to, similar to, or the same as, multi-position shut-off valve 110 shown in FIG. 1. For example, second multi-position shut-off valve 114 may be provided between fuel source 104 and pressure regulator 108 (e.g., as shown in FIG. 1) or between pressure regulator 108 and multi-position shut-off valve 110, and may be controlled, for example, via an engine control module 116 to regulate (e.g., increase and/or decrease) a flow rate of fuel and/or a fuel pressure of fuel flowing through one or more components of fuel system 102 to internal combustion engine 106.

As shown in FIG. 1, the direction of the fuel flow F is such that fuel flows through pressure regulator 108, then through multi-position shut-off valve 110, and finally through fuel valve 112 before being communicated to (e.g., injected into) internal combustion engine 106 for combustion. In some examples, as mentioned above, second multi-position shut-off valve 114 may be provided upstream from pressure regulator 108, multi-position shut-off valve 110, and fuel valve 106 relative to the direction of the fuel flow F through fuel system 102. Because, in some examples, second multi-position fluid shut-off valve 114 is placed upstream from other components of fuel system 102, second multi-position fluid shut-off valve 114 may control, for example, based on one or more signals from engine control module 116, one or more amounts of fuel, a fuel pressure associated with the fuel, and/or a fuel flow rate of fuel that flows through one or more components (e.g., a fuel filter, pressure regulator 108, fuel valve 112, and/or the like) of fuel system 102.

As shown in FIG. 1, an inlet pressure of pressure regulator 108 and an outlet pressure of pressure regulator 108 may be monitored. For example, one or more sensors 118 (e.g., temperature sensors, pressure sensors, and/or the like) may be configured to determine an inlet pressure upstream relative to pressure regulator 108 and/or an outlet pressure downstream relative to pressure regulator 108. In some such examples, a differential pressure for pressure regulator 108 may be determined based on the difference between the inlet pressure and the outlet pressure of pressure regulator 108. In some examples, if the pressure differential for pressure regulator 108, as sensed by the one or more sensors 118 is inconsistent with (e.g., it does not match) a configuration and/or setting of pressure regulator 108 (e.g., the parameter is outside of a threshold range of the setting), engine control module 116 may instruct second multi-position fluid shut-off valve 114 to increase or decrease the flow rate of fuel through second multi-position fluid shut-off valve 114. In some such examples, second multi-position fluid shut-off valve 114 may adjust a position and/or orientation of a valve body (e.g., a ball valve body, a spool valve body, a needle valve body, or any other type of valve body with shut-off capability) of second multi-position fluid shut-off valve 114 to enable the fuel flow rate of fuel through second multi-position fluid shut-off valve 114 to be increased or decreased. One or more other parameters in the form of data 118, for example, parameters other than inlet pressure and outlet pressure associated with pressure regulator 108, may be used to, at least in part, control operation of one or more of multi-position fluid shut-off valve 110 and/or second multi-position fluid shut off valve 114. For example, such parameters may be associated with the fuel flowing through fuel system 102, operating conditions of fuel system 102, and/or operation of internal combustion engine 106, and such parameters may be monitored and/or used to control the flow rate of fuel using second multi-position fluid shut-off valve 114 and/or multi-position fluid shut-off valve 110, for example, as explained herein. In some example, the inlet pressure of pressure regulator 108 may correspond to an outlet pressure of second multi-position fluid shut-off valve 114. Additionally, the outlet pressure of pressure regulator 108 may correspond to an inlet pressure of fuel valve 112.

In some examples, second multi-position fluid shut-off valve 114 facilitates a variable fuel flow rate through second multi-position fluid shut-off valve 114. For example, second multi-position fluid shut-off valve 114 may facilitate adjustment from a first flow rate between zero flow and maximum flow to and/or from a second flow rate between zero flow and/or maximum flow. For example, second multi-position fluid shut-off valve 114 may be configured to increase or decrease a fuel flow rate to and/or from 20% of maximum flow rate, to and/or from 30% of maximum flow rate, to and/or from 50% of maximum flow rate, to and/or from 75% of maximum flow rate, and/or the like. In some such examples, the fuel flow rate of fuel through second multi-position fluid shut-off valve 114 may depend on the position and/or orientation of the valve body of second multi-position fluid shut-off valve 114, which may be controlled, for example, by engine control module 116, for example, via an electrically controlled actuator. As a result, second multi-position fluid shut-off valve 114 may facilitate additional fuel flow rates through fuel system 102 other than zero flow (0% of maximum flow rate) and maximum flow (100% of maximum flow rate), though second multi-position fluid shut-off valve 114 may facilitate zero flow, maximum flow of fuel, and/or flow rates between zero flow and maximum flow.

In some examples, one or more additional multi-position fluid shut-off valves, for example, similar to second multi-position fluid shut-off valve 114, may be provided in parallel relative to one or more other components of fuel system 102. For example, an additional multi-position fluid shut-off valve may be provided in parallel relative to fuel valve 112. In some such examples, the additional multi-position fluid shut-off valve may be used to control an amount of fuel, a pressure of fuel, and/or a flow rate of fuel directly injected into internal combustion engine 106. The additional multi-position fluid shut-off valve may be used under certain operating conditions, for example, upon startup of internal combustion engine 106) as determined by engine control module 116 associated with internal combustion engine 106.

For example, as shown in FIG. 1, a secondary multi-position fluid shut-off valve 122 may be provided in parallel relative to multi-position fluid shut-off valve 110 and/or fuel valve 112 of fuel system 102. In some examples, secondary multi-position fluid shut-off valve 122 may facilitate full authority over fuel system 102 during a startup condition. In such examples, secondary multi-position fluid shut-off valve 122 may be used to initially start internal combustion engine 106. Once started, secondary multi-position fluid shut-off valve 122 may be closed during operation of internal combustion engine 106.

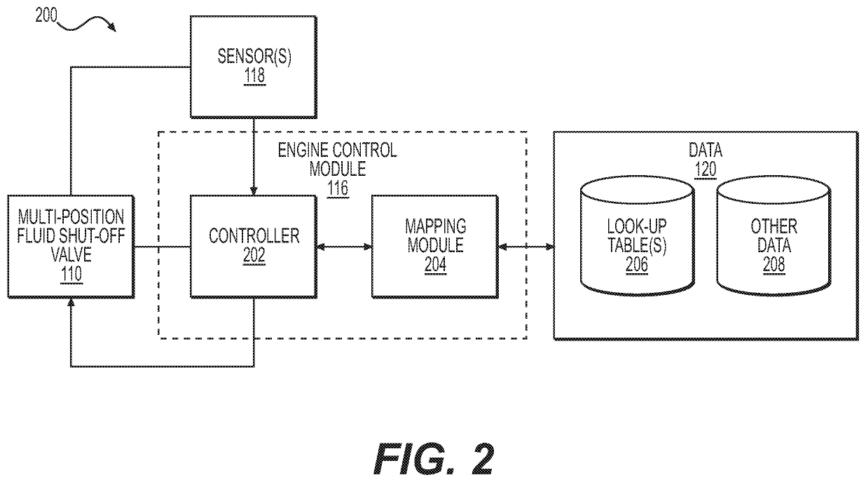

FIG. 2 is a schematic depiction of an example system 200 for shutting-off fluid flow and measuring flow rate in a fluid system, such as, for example, the fluid system 100 shown in FIG. 1. Example system 200 includes multi-position fluid shut-off valve 110 and a controller 202 coupled to multi-position fluid shut-off valve 110 and configured to selectively shut-off or allow fluid flow through multi-position fluid shut-off valve 110 and, in some examples, measure fluid flow rate through multi-position fluid shut-off valve 110 when in an open condition, as explained herein. In some examples, controller 202 may be configured to access (or incorporate therein) a mapping module 204 configured to store data for use by controller 202 for controlling operation of multi-position fluid shut-off valve 110, as explained herein. In some examples, mapping module 204 may incorporate therein or be in communication with data 120, which may include one or more look-up tables 206 and/or other data 208 related to operation of fluid system 100 and/or multi-position fluid shut-off valve 110. In some examples, controller 202 and/or mapping module 204 may be incorporated into engine control module 116, for example, as shown in FIG. 2. In some examples, data 120, look-up table(s) 206, and/or other data 208 may be incorporated into engine control module 116. In some examples, one or more of controller 202, mapping module 204, data 120, look-up table(s) 206, and/or other data 208 may be separate from one another and/or engine control module 116. In some examples, controller 202 may be in communication with one or more sensor(s) 118. One or more components of system 200 may be in communication with one another via wired connections, wireless connections, or a combination of wired and wireless connections.

As mentioned above, multi-position fluid shut-off valve 110 may be configured to selectively shut-off or allow fluid flow through multi-position fluid shut-off valve 110 and, in some examples, measure fluid flow rate through multi-position fluid shut-off valve 110. In some examples, multi-position fluid shut-off valve 110 may not be configured to be used solely to alter fluid flow rate in the fluid system 100. In some such examples, second multi-position fluid shut-off valve 114 (FIG. 1), alone or in combination with other valves or similar structures, may be used to alter fluid flow rate through at least portions of fluid system 100 (e.g., to alter flow rate to internal combustion engine 106), and multi-position fluid shut-off valve 110 may be configured to selectively shut-off or allow fluid flow through multi-position fluid shut-off valve 110 and/or to measure fluid flow rate through multi-position fluid shut-off valve 110. In some examples, multi-position fluid shut-off valve 110 may be controlled by controller 202 and/or engine control module 116. For example, as explained in more detail herein, a position and/or orientation of a valve body of multi-position fluid shut-off valve 110 (e.g., a substantially spherical valve body) may be repositioned and/or re-oriented according to one or more signals from controller 202 and/or engine control module 116.

Sensor(s) 118 may include any type of sensor configured to measure one or more parameters of fuel system 100, internal combustion engine 106, or one or more ambient conditions. Sensor(s) 118 may be sensors of a sensor system that is communicatively coupled with controller 202 and/or engine control module 116, as described herein. For example, sensor(s) 118 may include temperature sensors, for example, configured to generate signals indicative of fluid temperature (e.g., fuel temperature), ambient air temperature, exhaust temperature, a component temperature, coolant temperature, and/or the like), position sensors, for example, configured to generate signals indicative of a position and/or orientation of a valve body, an actuator, an engine part (e.g., a piston), and/or the like, speed sensors, for example, configured to generate signals indicative of engine speed, a machine speed, and/or the like, pressure sensors, for example, configured to generate signals indicative of compression of air and/or fuel in fuel system 100, emissions sensors, for example, configured to generate one or more signals indicative of emission levels associated with operation of internal combustion engine 106, combustion sensors, for example, configured to generate signals indicative of one or more components of combustion, and/or other sensors.

Sensor(s) 118 may be associated with a sensing parameter that may be used in determining a fuel flow rate, fuel pressure, fuel mass flow, and/or the like associated with fuel system 100. For example, a value of the sensing parameter for one or more sensor(s) 118 may represent or indicate a measurement of the sensor(s) 118, such as, for example, a measured pressure of a pressure sensor, a measured temperature of a temperature sensor, a measured timing of a valve (e.g., fuel valve 112) opening and/or closing by a position sensor, a measured engine speed (e.g., engine speed of internal combustion engine 106) by a speed sensor, a measured position and/or orientation of an actuator or valve body (e.g., a valve body of multi-position fluid shut-off valve 110, fuel valve 112, and/or the like) by a position/orientation sensor, measured emissions by an emissions sensor, and/or the like.

In some examples, engine control module 116 may facilitate control of second multi-position fluid shut-off valve 114, for example, in order to control a fuel flow rate through fuel system 102 and/or through various components of fuel system 102 according to one or more signals generated by one or more of sensor(s) 118. Engine control module 116 and/or controller 202, in some examples, may be implemented as a processor, such as a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. The processor may be implemented in hardware, firmware, or a combination of hardware and software. In some implementations, engine control module 116 and/or controller 202 may include one or more processors capable of being programmed to perform a function. In some examples, one or more memories, including a random-access memory (RAM), a read-only memory (ROM), and/or another type of dynamic or static storage device (e.g., a flash memory, a magnetic memory, and/or an optical memory) may store information and/or instructions for use by engine control module 116 and/or controller 202. In some examples, engine control module 116 and/or controller 202 may include a memory (e.g., a non-transitory computer-readable medium) capable of storing instructions, that when executed, cause the processor to perform one or more processes and/or methods described herein. A computer-readable medium may be defined herein as a non-transitory memory device. A memory device may include memory space within a single physical storage device or memory space spread across multiple physical storage devices.

Engine control module 116 and/or controller 202 may execute the instructions to perform various control functions and processes to control multi-position fluid shut-off valve 110 and/or second multi-position fluid shut-off valve 114, and, as such, to automatically control a flow rate of fuel through fuel system 100 and/or through various components of fuel system 100. Engine control module 116 and/or controller 202 may include any appropriate type of engine control system configured to perform engine control functions, such that internal combustion engine 106 may operate properly. In some examples, engine control module 116 and/or controller 202 may also at least partially control other systems of a machine, such as transmission systems, electronic systems, hydraulics systems, actuators, and/or the like.

In some examples, in operation, computer software instructions may be stored in and/or loaded onto engine control module 116 and/or controller 202. Engine control module 116 and/or controller 202 may execute the computer software instructions to perform various control functions and processes related to multi-position fluid shut-off valve 110 and/or second multi-position fluid shut-off valve 114, for example, to adjust (automatically or otherwise) one or more parameters of fuel system 102, such as, for example, an inlet pressure of a pressure regulator (e.g., pressure regulator 108), a fuel mass flow of fuel through at least portions of fuel system 102, measure flow rate through multi-position fluid shut-off valve 110 and/or fuel system 102, and/or the like. Additionally, or alternatively, engine control module 116 and/or controller 202 may execute computer software instructions to generate and/or cause one or more of sensor(s) 118 to provide fuel system and/or engine temperature values, fuel system and/or engine pressure values, engine emission values, engine speed values, actuator and/or valve body position/orientation values, and/or other parameter values that may be used to monitor fuel system 102 and/or internal combustion engine 106.

In some examples, engine control module 116 and/or controller 202 may identify, obtain, and/or determine parameters that are associated with conditions (e.g., as sensed by one or more of sensor(s) 118) or settings corresponding to the operations of fuel system 102 and/or internal combustion engine 106, such as, for example, fuel rate or quantity, engine speed, fuel injection timing, intake manifold temperature (IMAT), intake manifold pressure (IMAP), intake valve actuation (IVA), IVA timing, intake throttle valve position, air injection pressure, fuel injection pressure, torque delivered by internal combustion engine 106, total fuel injection quantity, exhaust pressure, oxygen/fuel molar ratio, ambient temperature, ambient pressure (e.g., barometric pressure), mass flow through fuel system 102, exhaust backpressure valve position, coolant temperature, and/or the like.

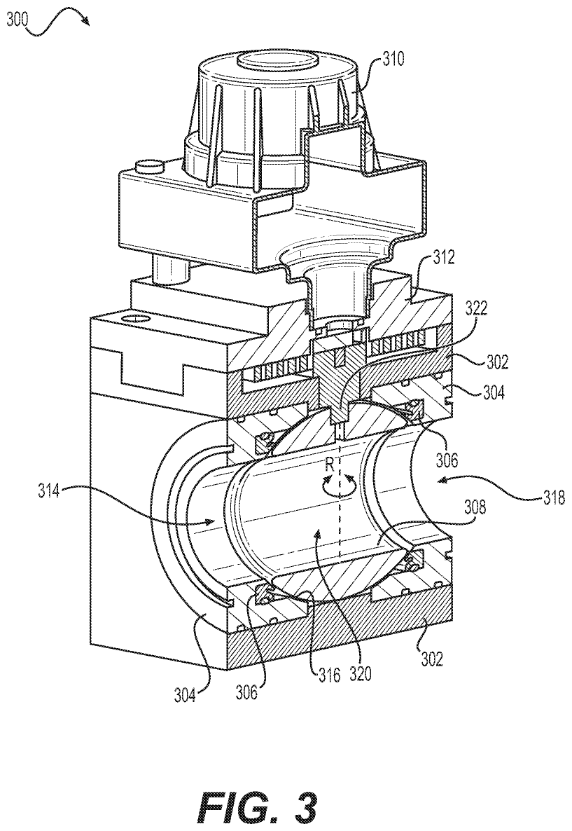

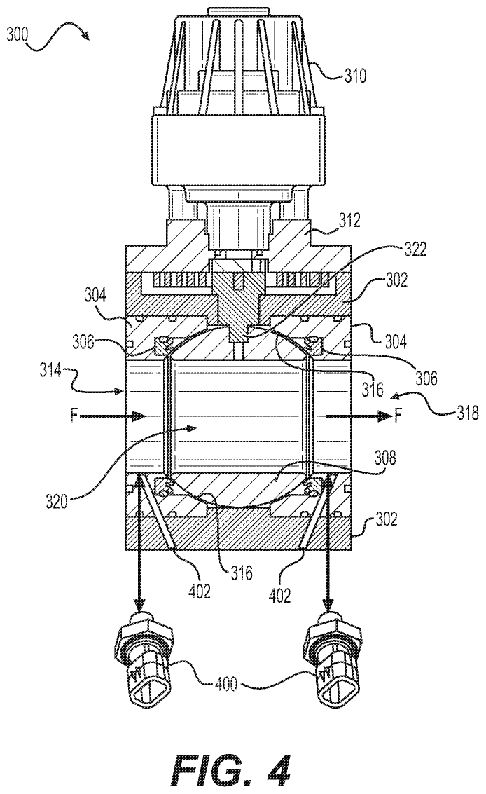

FIGS. 3 and 4 show an example multi-position fluid shut-off valve 300 that may correspond to multi-position fluid shut-off valve 110, second multi-position fluid shut-off valve 114, and/or secondary multi-position fluid shut-off valve 122, as shown in FIGS. 1 and 2. Example multi-position fluid shut-off valve 300 may include a housing 302, a seal support 304 configured to support one or more fluid line seal(s) 306 (e.g., annular seals), a valve body 308 (e.g., a substantially spherical valve body or ball valve body), an actuator 310 (e.g., a motor), and an actuator mount 312 configured to couple actuator 310 to housing 302. For example, housing 302 may at least partially define an inlet 314 configured to receive a fluid, a valve body chamber 316 configured to receive valve body 308, and an outlet 318 opposite inlet 314 relative to valve body chamber 316 and through which fluid exits multi-position fluid shut-off valve 300. In some examples, valve body 308 may be substantially spherical and may be at least partially received in valve body chamber 316. Other valve body configurations are contemplated. Example valve body 308 defines a valve body passage 320 configured to selectively provide flow communication between inlet 314 and outlet 318 of housing 302, for example, when valve body 308 is positioned and/or oriented, such that valve body passage 320 is at least partially aligned with inlet 314 and outlet 318, for example, as shown in FIGS. 3 and 4. Actuator 310 may include an actuator shaft 322 coupled to valve body 308 (either directly or indirectly), and actuator 310 may be configured to reposition and/or re-orient valve body 308 relative to valve body chamber 316 of housing 302, for example, by applying torque to actuator shaft 322, such that valve body passage 320 moves and/or re-orients as schematically denoted by arrow R to misalign valve passage 320 relative to inlet 314 and outlet 318 of housing 302. For example, by rotating valve body 308 between zero degrees and 90 degrees of rotation, valve body passage 320 may be repositioned and/or re-oriented, such that valve body passage 320 moves from a position and/or orientation substantially aligned with inlet 314 and/or outlet 318 (as shown in FIGS. 3 and 4), such that fluid flows through multi-position fluid shut-off valve 300, to a position and/or orientation substantially or completely blocking inlet 314 and/or outlet 318, such that fluid is mostly or completely blocked from flowing through multi-position fluid shut-off valve 300.

As schematically shown in FIG. 4, some examples of system may also include one or more pressure sensor(s) 400 in flow communication with the housing 302. For example, the one or more pressure sensor(s) 400 may be configured to generate a pressure differential signal indicative of a pressure difference between an inlet fluid pressure associated with inlet 314 and an outlet pressure associated with outlet 318. In some examples, one or more of pressure sensor(s) 400 may be in fluid communication with inlet 314 and/or outlet 318 via respective passages 402, for example, as schematically depicted in FIG. 4. In some examples, one or more of pressure sensor(s) 400 may be integrated into housing 302.

In some examples, multi-position fluid shut-off valve 300 may be configured to operate as both a fluid shut-off valve and a device for measuring flow rate of fluid flowing through multi-position fluid shut-off valve 300. For example, multi-position fluid shut-off valve 300 may operate as multi-position fluid shut-off valve 110 shown in FIG. 1. In some such examples, as shown in FIG. 2, engine control module 116 may include (or be in communication with) controller 202 and mapping module 204. Controller 202 may be configured to control multi-position fluid shut-off valve 300 according to one or more mappings of mapping module 204. As described herein, controller 202 may adjust the position and/or orientation of valve body 308 of multi-position fluid shut-off valve 300 via one or more control signals and/or instructions sent to actuator 310 to reposition and/or re-orient valve body 308 relative to valve body chamber 316, for example, as described herein. Based on the signal and/or instructions, actuator 310 of multi-position fluid shut-off valve 300 may pivot and/or rotate valve body 308 of multi-position fluid shut-off valve 300 to a corresponding position. Additionally, or alternatively, multi-position fluid shut-off valve 300 may include a controller (e.g., a device that includes a processor, a memory, and/or the like similar to engine control module 116) configured to control multi-position fluid shut-off valve 300 independently from a separate engine control module. In some such examples, multi-position fluid shut-off valve 300 may serve as a slave control module, capable of operating multi-position fluid shut-off valve 300 according to information generated by one or more of sensor(s) 118, and an engine control module (e.g., engine control module 116) may serve as a master control module configured to control controller 202 of multi-position fluid shut-off valve 300.

In some examples, controller 202 may include one or more devices configured to control multi-position fluid shut-off valve 300, as described herein. For example, controller 202 may be configured, in some examples, via a user interface and/or default settings, to shut-off flow through multi-position fluid shut-off valve 300 by causing actuator 310 to reposition and/or re-orient (e.g., rotate) valve body 308, such that valve body passage 320 is closed relative to inlet 314 and/or outlet 318 of housing 302. In some examples, controller 202 may be configured, for example, via a user interface and/or default settings, to measure fluid flow rate through multi-position fluid shut-off valve 300 across a wide range of turndown ratios (e.g., a wide range of ratios of maximum fluid flow rates to minimum fluid flow rates). For example, multi-position fluid shut-off valve 300 may be configured to accurately measure fluid flow rates through multi-position fluid shut-off valve 300 across a wide range of fluid flow rates by repositioning and/or re-orienting valve body 308 and measuring pressure differential across inlet 314 and outlet 318 of multi-position fluid shut-off valve 300. For example, the effective range of flow rate measurement capability of multi-position fluid shut-off valve 300 may be altered by rotating valve body 308 between measurement positions from zero degrees (e.g., with valve body passage 320 aligned with respect to inlet 314 and outlet 318) to ninety degrees (e.g., with valve body passage 320 completely orthogonal with respect to inlet 314 and outlet 318) at which point multi-position fluid shut-off valve 300 effectively shuts-off fluid flow through multi-position fluid shut-off valve 300. In some examples, each position and/or orientation between zero degrees and ninety degrees corresponds to a capability to accurately measure a different range of fluid flow rates through multi-position fluid shut-off valve 300.

For example, some examples of controller 202 may be configured to receive a valve body signal indicative of a valve body position of valve body 308 relative to valve body chamber 316 and/or a valve body orientation of valve body 308 relative to valve body chamber 316. For example, controller 202 may be configured store in memory and/or access data corresponding to positions and/or orientations of valve body 308 (e.g., from data 120 and or other data 208, see FIG. 2). In some examples, controller 202 may be configured to receive the valve body signal from actuator 310. In addition, some examples of controller 202 may be configured to receive a pressure differential signal indicative of the pressure difference associated with inlet 314 and outlet 318. For example, as shown in FIG. 4, a first pressure sensor 400 may be in flow communication with inlet 314, and a second pressure sensor 400 may be in flow communication with outlet 318, with each of the pressure sensors 400 being configured to generate one or more signals indicative of fluid pressure of fluid at inlet 314 and outlet 318, respectively. Pressure sensors 400 may be any suitable known pressure sensors having an effective pressure sensing within a suitable/desirable pressure range. Controller 202 may be configured to receive signals from the two pressure sensors and determine a pressure differential corresponding to a pressure difference between the two pressures at the inlet 314 and the outlet 318.

In some examples, controller 202 may be configured to determine a flow rate of fluid flowing through multi-position fluid shut-off valve 300 based at least in part on the valve body signal and the pressure differential signal. For example, referring to FIG. 2, controller 202 may access data 120 and calculate the flow rate based at least in part on the valve body signal indicative of the valve body position and/or orientation relative to valve body chamber 316 and/or the pressure differential signal. In some examples, accessing the data 120 may include accessing one or more look-up table(s) 206 (FIG. 2) providing correlations between the valve body position and/or orientation, the pressure differential, and a flow coefficient corresponding to the valve body position and/or orientation and the pressure differential. For example, controller 202 may be configured to identify the flow coefficient from one or more of the look-up table(s) 206 that corresponds to the valve body position and/or orientation and the pressure differential, and calculate the fluid flow rate through multi-position fluid shut-off valve 300 using the flow coefficient, the valve body position and/or orientation, and/or the pressure differential, according to known fluid flow dynamics formulas. In some examples, one or more of the look-up table(s) 206 may also include data or information related to the effective flow area associated with the valve body position and/or orientation. The flow coefficients in the look-up table(s) 206 may be empirically and/or theoretically derived, for example, though experimentation and/or known fluid dynamics formulas. In some examples, flow coefficients may be unique to each multi-position fluid shut-off valve 300 or group of multi-position fluid shut-off valves.

In some examples, controller 202 may also be configured to receive a temperature signal indicative of a temperature of fluid flowing through multi-position fluid shut-off valve 300 and determine the flow rate of the fluid flowing through multi-position fluid shut-off valve 300 based at least in part on the temperature signal and the valve body signal and/or the pressure differential signal. In some examples, the temperature sensor(s) may be integrated into multi-position fluid shut-off valve 300, and in some examples, the temperature sensor(s) may be independent of multi-position fluid shut-off valve 300. The use of any suitable known temperature sensors is contemplated.

In some examples, controller 202 may also be configured to receive a fluid characterization signal indicative of at least one characteristic of the fluid and determine the flow rate of the fluid flowing through multi-position fluid shut-off valve 300 based at least in part on the fluid characterization signal, the valve body signal, the pressure differential signal, and/or the temperature signal. In some examples, the fluid characterization signal may be manually entered via an input device, such as a computer input device. In some examples, the fluid characterization signal may be generated by one or more of the sensor(s) 118. The at least one fluid characteristic may include one or more of fluid type, fluid density, fluid components, viscosity, or any other known fluid characteristics, such as those that might affect fluid flow.

In some examples, controller 202 may be configured to determine fluid flow rate at different flow rate ranges and/or according to different flow rate turndown ratios. For example, multi-position fluid shut-off valve 300 and controller 202 may be configured to determine flow rate within a first range of flow rate ranges and/or at a first turndown ratio. This first determination may correspond to a first position and/or orientation of valve body 308. Therefore, for example, if flow conditions in the fluid system change such that the fluid flow rate through multi-position fluid shut-off valve 300 changes to a magnitude outside of the first range and/or the first turndown ratio, controller 202 may cause the actuator to reposition and/or re-orient valve body 308, such that controller 202 determines fluid flow rate through multi-position fluid shut-off valve 300 within a second range of flow rates and/or at a second turndown ratio, where the second range of flow rates and/or the second turndown ratio differs respectively from the first range of flow rates and/or the first turndown ratio. In such examples, multi-position fluid shut-off valve 300 may be capable of repositioning and/or reorienting of valve body 308 to measure fluid flow rates through multi-position fluid shut-off valve 300 based on repositioning and/or reorienting valve body 308 using controller 202. In some such examples, controller 202 may access one or more of look-up tables 206 and/or other data 208 (e.g., temperature, fluid system characteristics, and/or fluid characteristics) to determine fluid flow rate through multi-position fluid shut-off valve 300 based on one or more of the valve body signals, the pressure differential signals, temperature signals, or fluid characterization signals.

For example, controller 202 may be configured to receive a parameter signal indicative of operation of a fluid system in flow communication with the system, and cause actuator 310 to (1) reposition valve body 308 relative to the valve body chamber 316 from a first position to a second position and/or (2) re-orient valve body 308 relative to valve body chamber 316 from a first orientation to a second orientation. The parameter signal may be indicative of any characteristic (or change thereof) related to the fluid, the fluid system (e.g., pressure and/or flow rate in another part of the fluid system), and/or other components of the fluid system. Thereafter, in some examples, controller 202 may be configured to receive a second valve body signal indicative of a second position and/or a second orientation, receive a second pressure differential signal indicative of the pressure difference, and determine a second flow rate of the fluid flowing through the multi-position fluid shut-off valve 300 based at least in part on at least the second valve body signal and the second pressure differential signal, wherein the second flow rate is within a second range of flow rates, the second range of flow rates being different than the first range of flow rates. In some such examples, the upper end of the second range of flow rates may be higher than the upper end of the first range of flow rates by a multiplication factor. The multiplication factor may range from, for example, above one to about ten-thousand, for example, from about two to about ten-thousand, from about ten to about ten-thousand, from about one-hundred to about ten-thousand, from above about one to about one-thousand, from above about one to about one-thousand, or from above about one to about one-hundred. In some examples, the range of flow rates may be limited by the measuring capabilities of one or more of the pressure sensors 400.

In some examples, controller 202 may be configured to cause actuator 310 to reposition and/or reorient valve body 308, thereby increasing the turndown ratio associated with the range of flow rates measurable by multi-position fluid shut-off valve 300. In some examples, the turndown ratio may range, for example, from about ten to about sixty-thousand, from about twenty to about sixty-thousand, from about thirty to about sixty-thousand, from about fifty to about sixty-thousand, from about one-hundred to about sixty-thousand, from about one-thousand to about sixty-thousand, from about twenty to about fifty-thousand, from about twenty to about ten-thousand, from about twenty to about one-thousand, or from about twenty to about one-hundred. In some examples, the range of turndown ratios may be limited by the capabilities of one or more of the pressure sensors 400.

### INDUSTRIAL APPLICABILITY

The exemplary system and related methods of the present disclosure may be applicable to a variety of fluid systems and fluid types. For example, the system for shutting-off fluid flow and measuring fluid flow rate may be incorporated into a fuel system, for example, for an internal combustion engine. Some examples of the system may be incorporated into other types of fluid systems, such as, for example, cooling systems, hydraulic systems, lubrication systems, HVAC systems, or any other fluid system for which fluid flow shut-off and/or fluid flow rate measurement may be desirable.

Some examples of the system may provide an ability to measure a wide range of fluid flow rates within a fluid system, for example, by control of the position and/or orientation of a valve body in a multi-position fluid shut-off valve, for example, as described herein. Some such examples may result in a providing a fluid flow rate measurement having a large turndown ratio, for example, a relatively larger turndown ratio than conventional fluid flow rate measuring devices.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

What is claimed is:

1. A system for shutting-off fluid flow and measuring fluid flow rate, the system comprising:
a housing defining an inlet configured to receive a fluid, a valve body chamber, and an outlet opposite the inlet relative to the valve body chamber;
a valve body at least partially received in the valve body chamber;
an actuator coupled to the valve body and configured to at least one of reposition the valve body relative to the valve body chamber or re-orient the valve body relative to the valve body chamber;
at least one pressure sensor in flow communication with the housing, the at least one pressure sensor configured to generate a pressure differential signal indicative of a pressure difference between an inlet fluid pressure associated with the inlet and an outlet fluid pressure associated with the outlet; and
a controller configured to:
receive a valve body signal indicative of at least one of a valve body position of the valve body or a valve body orientation of the valve body;
receive the pressure differential signal indicative of the pressure difference; and
determine a flow rate of a fluid flowing through the housing based at least in part on at least one of the valve body signal and the pressure differential signal.

2. The system of claim 1, wherein the flow rate is a first flow rate within a first range of flow rates, and the valve body is in at least one of a first position or a first orientation, and
wherein the controller is further configured to:
receive a parameter signal indicative of operation of a fluid system in flow communication with the housing;
cause the actuator to at least one of (1) reposition the valve body from a first position to a second position or (2) re-orient the valve body from a first orientation to a second orientation;
receive a second valve body signal indicative of the at least one of the second position or the second orientation;
receive a second pressure differential signal indicative of a second pressure difference; and
determine a second flow rate of the fluid flowing through the housing based at least in part on the second valve body signal and the second pressure differential signal,
wherein the second flow rate is within a second range of flow rates, the second range of flow rates being different than the first range of flow rates.

3. The system of claim 2, wherein an upper end of the second range of flow rates is higher than an upper end of the first range of flow rates by a multiplication factor, and wherein the multiplication factor ranges from about two to about ten-thousand.

4. The system of claim 2, wherein the parameter signal comprises a parameter fluid system pressure signal indicative of a pressure associated with the fluid system.

5. The system of claim 1, wherein the valve body is substantially spherical and defines a passage configured to provide flow through the valve body.

6. The system of claim 1, wherein the controller is further configured to receive a temperature signal and determine the flow rate of the fluid flowing through the housing based at least in part on the temperature signal and at least one of the valve body signal and the pressure differential signal.

7. The system of claim 1, wherein the controller is further configured to receive a fluid characterization signal indicative of at least one characteristic of the fluid and determine the flow rate of the fluid flowing through the housing based at least in part on the fluid characterization signal and at least one of the valve body signal or the pressure differential signal.

8. The system of claim 1, wherein the controller is configured to determine a flow coefficient for fluid flow through the housing based at least in part on the valve body signal indicative of at least one of the valve body position or the valve body orientation.

9. The system of claim 8, wherein the controller is configured to determine the flow coefficient by accessing a look-up table including correlations between the flow coefficient and the at least one of the valve body position or the valve body orientation.

10. A system for shutting-off fluid flow and measuring fluid flow rate, the system comprising:
a housing defining an inlet configured to receive a fluid, a valve body chamber, and an outlet opposite the inlet relative to the valve body chamber;
a valve body at least partially received in the valve body chamber;
an actuator coupled to the valve body and configured to change at least one of an area through which the fluid flows through the housing or a flow coefficient associated with fluid flow through the housing;
at least one pressure sensor in flow communication with the housing, the at least one pressure sensor configured to generate a pressure differential signal indicative of a pressure difference between an inlet fluid pressure associated with the inlet and an outlet fluid pressure associated with the outlet; and
a controller configured to:
receive a valve body signal indicative of at least one of a valve body position or a valve body orientation;
receive the pressure differential signal indicative of the pressure difference; and
determine a flow rate of a fluid flowing through the housing based at least in part on at least one of the valve body signal and the pressure differential signal.

11. The system of claim 10, wherein the controller is configured to determine a flow coefficient for fluid flow through the housing based at least in part on the valve body signal.

12. The system of claim 11, wherein the controller is configured to determine the flow coefficient by accessing a look-up table including correlations between the flow coefficient and the at least one of the valve body position or the valve body orientation.

13. The system of claim 11, wherein the controller is configured to increase a turndown ratio of the system, the turndown ratio comprising a ratio of a maximum measurable fluid flow rate through the housing to a minimum measurable fluid flow rate through the housing.

14. The system of claim 13, wherein the controller is configured to increase the turndown ratio by causing the actuator to at least one of reposition the valve body or re-orient the valve body.

15. A system for shutting-off fluid flow and measuring fluid flow rate, the system comprising:
a housing defining an inlet configured to receive a fluid, a valve body chamber, and an outlet opposite the inlet relative to the valve body chamber;
a valve body at least partially received in the valve body chamber;
an actuator coupled to the valve body and configured to at least one of reposition the valve body or re-orient the valve body;
at least one pressure sensor in flow communication with the housing, the at least one pressure sensor configured to generate a pressure differential signal indicative of a pressure difference
between an inlet fluid pressure associated with the inlet and an outlet fluid pressure associated with the outlet; and
a controller configured to:
determine a first flow rate through the housing based at least in part on a first pressure differential signal, the first flow rate being within a first range of flow rates;
cause the actuator to at least one of (1) reposition the valve body from a first position to a second position or (2) re-orient the valve body from a first orientation to a second orientation; and
determine a second flow rate through the housing based at least in part on a second pressure differential signal, the second flow rate being within a second range of flow rates,
wherein the second range of flow rates is different than the first range of flow rates.

16. The system of claim 15, wherein the controller is configured to:
receive a first valve body signal indicative of the at least one of the first position or the first orientation;
determine the first flow rate based at least in part on the first valve body signal and the first pressure differential signal;
receive a second valve body signal indicative of the at least one of the second position or the second orientation; and
determine the second flow rate based at least in part on the second valve body signal and the second pressure differential signal.

17. The system of claim 16, wherein the controller is configured to determine a first flow coefficient for fluid flow through the housing based at least in part on the first valve body signal and determine a second flow coefficient for fluid flow through the housing based at least in part on the second valve body signal.

18. The system of claim 15, wherein an upper end of the second range of flow rates is higher than an upper end of the first range of flow rates by a multiplication factor, and wherein the multiplication factor ranges from about two to about ten-thousand.

19. The system of claim 15, wherein the controller is configured to increase a turndown ratio of the system, the turndown ratio comprising a ratio of a maximum measurable fluid flow rate through the housing to a minimum measurable fluid flow rate through the housing.

20. The system of claim 19, wherein the controller is configured to increase the turndown ratio by causing the actuator to at least one of reposition the valve body or re-orient the valve body.
